(19) United States
(12) Patent Application Publication
(10) Pub. No.: US 2025/0130319 A1
(43) Pub. Date: Apr. 24, 2025

(54) PHOTOELECTRIC CONVERSION DEVICE

(71) Applicant: CANON KABUSHIKI KAISHA, Tokyo (JP)

(72) Inventor: MASASHI NIWA, Chiba (JP)

(21) Appl. No.: 18/917,024

(22) Filed: Oct. 16, 2024

(30) Foreign Application Priority Data
Oct. 19, 2023 (JP) 2023-180216

(51) Int. Cl. G01S 7/4861; G01S 17/10; G01S 17/931

(52) U.S. Cl. CPC G01S 7/4861; G01S 17/10; G01S 17/931

(57) ABSTRACT

A photoelectric conversion device includes a timing generation unit periodically generating a first and second timings indicating light emission timings in a first and second modes, respectively, a light receiving unit generating a light reception signal based on incident light incident in an exposure period, and an exposure period control unit. A length of a cycle of the second timing is longer than that of the first timing. In the first mode, the exposure period control unit generates the control signal indicating a timing of the exposure period having a time width corresponding to one of periods into which one cycle of the first timing is divided. The exposure period control unit determines the timing of the exposure period in the second mode based on a frequency distribution in which a count value of the light reception signal is associated with each exposure period in the first mode.

### BACKGROUND

### Technical Field

The present disclosure relates to a photoelectric conversion device.

### Description of the Related Art

In International Publication No. WO2017/141957, a ranging technique is disclosed in which light is emitted from a light source to an object and a distance to the object is measured from a relationship between a light emission timing of the light source and a light reception timing of reflected light from the object. In the ranging technique of International Publication No. WO2017/141957, measurement is repeatedly performed while changing an exposure period in which a photon is received by the light receiving element. In International Publication No. WO2017/141957, ranging is performed by two-stage processing in which the length of the exposure period and the light emission cycle are different from each other.

In a photoelectric conversion device used in a ranging technique as described in International Publication No. WO2017/141957, a further reduction in measurement time may be required.

### SUMMARY

According to one disclosure of the present specification, there is provided a photoelectric conversion device including a timing generation unit configured to periodically generate a first timing indicating a light emission timing of a light emitting device in a first mode and periodically generate a second timing indicating a light emission timing of the light emitting device in a second mode, a light receiving unit configured to generate a light reception signal based on incident light incident in an exposure period, and an exposure period control unit configured to generate a control signal that controls a timing of the exposure period. A length of a cycle of the second timing is longer than a length of a cycle of the first timing. In the first mode, the exposure period control unit generates the control signal indicating a timing of the exposure period having a time width corresponding to one of a plurality of periods into which one cycle of the first timing is divided. The exposure period control unit determines the timing of the exposure period in the second mode based on a frequency distribution in which a count value of the light reception signal is associated with each of a plurality of the exposure periods in the first mode.

An object of the present disclosure is to provide a photoelectric conversion device capable of reducing a measurement time.

Further features of the present disclosure will become apparent from the following description of exemplary embodiments with reference to the attached drawings.

### BRIEF DESCRIPTION OF THE DRAWINGS

FIG. 1 is a hardware block diagram illustrating a schematic configuration example of a ranging device according to a first embodiment.

FIG. 2 is a schematic diagram illustrating an overall configuration of a photoelectric conversion device according to the first embodiment.

FIG. 3 is a schematic block diagram illustrating a configuration example of a sensor substrate according to the first embodiment.

FIG. 4 is a schematic block diagram illustrating a configuration example of a circuit substrate according to the first embodiment.

FIG. 5 is a schematic block diagram illustrating a configuration example of one pixel of a photoelectric conversion unit and a pixel signal processing unit according to the first embodiment.

FIGS. 6A, 6B, and 6C are diagrams illustrating an operation of an avalanche photodiode according to the first embodiment.

FIG. 7 is a functional block diagram illustrating a schematic configuration example of the ranging device according to the first embodiment.

FIG. 8 is a schematic diagram for explaining a ranging frame and a sub-frame and a micro-frame in a first mode period and a second mode period according to the first embodiment.

FIGS. 9A and 9B are timing charts illustrating a ranging method according to the first embodiment.

FIG. 10 is a schematic diagram illustrating a frequency distribution acquired by the ranging method according to the first embodiment.

FIGS. 11A and 11B are timing charts illustrating the ranging method according to the first embodiment.

FIG. 12 is a schematic diagram illustrating a frequency distribution acquired by the ranging method according to the first embodiment.

FIG. 13 is a functional block diagram illustrating a schematic configuration example of a photoelectric conversion device and a ranging processing device according to a second embodiment.

FIG. 14 is a schematic diagram for explaining a ranging frame and sub-frames in a first mode period and a second mode period according to the second embodiment.

FIGS. 15A and 15B are timing charts illustrating a ranging method according to a third embodiment.

FIGS. 16A, 16B, 16C, and 16D are timing charts illustrating the ranging method according to the third embodiment.

FIG. 17 is a schematic diagram illustrating a frequency distribution acquired by the ranging method according to the third embodiment.

FIGS. 18A, 18B, and 18C are timing charts illustrating a ranging method according to a fourth embodiment.

FIG. 19 is a schematic diagram illustrating a frequency distribution acquired by the ranging method according to the fourth embodiment.

FIGS. 20A, 20B, 20C, and 20D are timing charts illustrating the ranging method according to the fourth embodiment.

FIG. 21 is a schematic diagram illustrating a frequency distribution acquired by the ranging method according to the fourth embodiment.

FIGS. 22A and 22B are schematic diagrams of equipment according to a fifth embodiment.

### DESCRIPTION OF THE EMBODIMENTS

Hereinafter, embodiments of the present disclosure will be described with reference to the drawings. The same or corresponding elements are denoted by the same reference numerals throughout the several drawings, and the description thereof may be omitted or simplified.

### First Embodiment

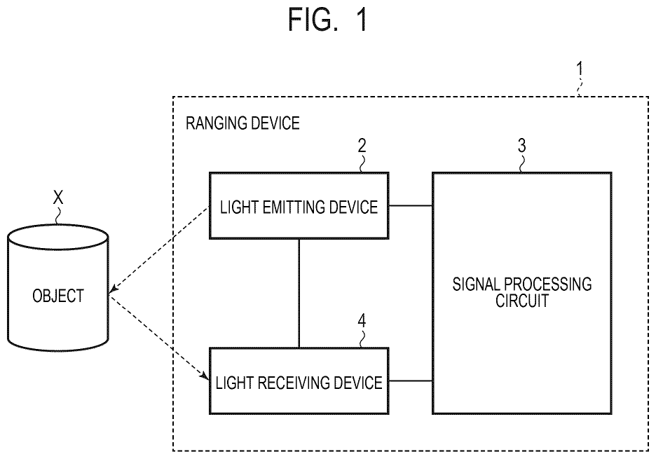

FIG. 1 is a hardware block diagram illustrating a schematic configuration example of a ranging device 1 according to the present embodiment. The ranging device 1 includes a light emitting device 2, a signal processing circuit 3, and a light receiving device 4. Note that the configuration of the ranging device 1 illustrated in the present embodiment is merely an example, and the present disclosure is not limited to the illustrated configuration.

The ranging device 1 is a device that measures a distance to an object X to be measured using a technique such as a light detection and ranging (LiDAR). The ranging device 1 measures a distance from the ranging device 1 to the object X based on a time difference between when the light is emitted from the light emitting device 2 and when the light reflected by the object X is received by the light receiving device 4. In addition, the ranging device 1 can measure a plurality of two-dimensional distances by emitting laser light to a predetermined ranging area including the object X and receiving reflected light by a pixel array. Thus, the ranging device 1 can generate and output a distance image.

The light received by the light receiving device 4 includes ambient light such as sunlight in addition to reflected light from the object X. Therefore, the ranging device 1 performs ranging in which the influence of ambient light is reduced by using a method of measuring the incident light in each of a plurality of periods (exposure periods) to generate a frequency distribution, and determining that reflected light is incident in a period in which the amount of light is maximum.

The light emitting device 2 is a device that emits light such as laser light to the outside of the ranging device 1. The signal processing circuit 3 may include a processor that performs arithmetic processing of a digital signal, a memory that stores a digital signal, and the like. The signal processing circuit 3 may be, for example, an integrated circuit such as a field-programmable gate array (FPGA) or an image signal processor (ISP).

The light receiving device 4 generates a pulse signal including a pulse based on the incident light. The light receiving device 4 is, for example, a photoelectric conversion device including an avalanche photodiode as a photoelectric conversion element. In this case, when one photon enters the avalanche photodiode and a charge is generated, one pulse is generated by avalanche multiplication. However, the light receiving device 4 may be, for example, a photoelectric conversion element using another photodiode. That is, the ranging device 1 is a type of photoelectric conversion device that performs ranging using photoelectric conversion.

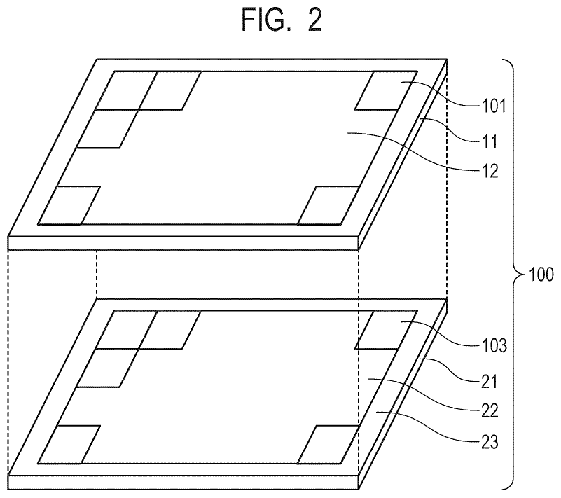

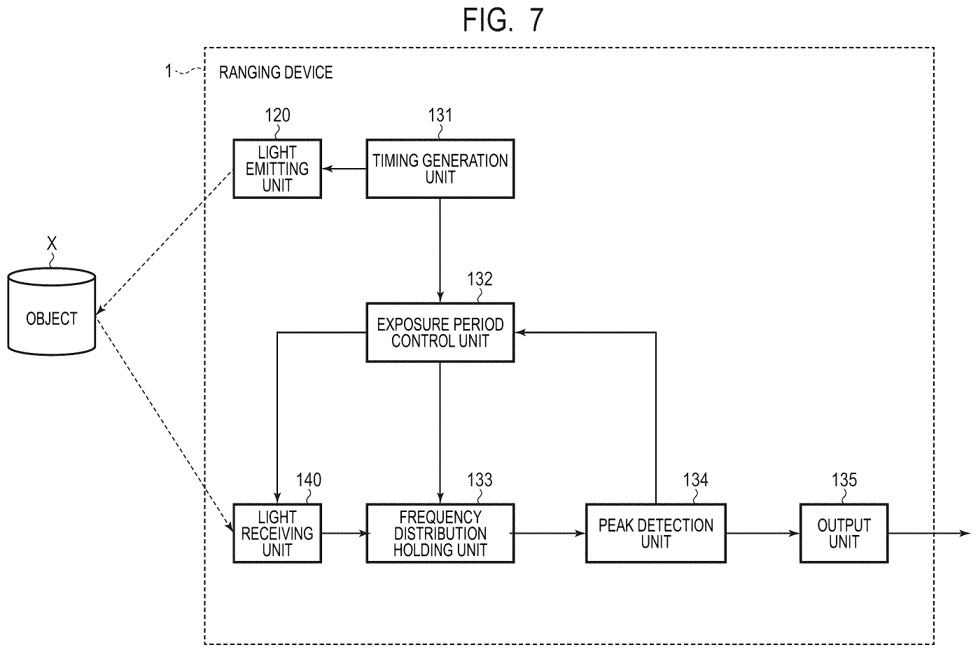

In the present embodiment, the light receiving device 4 includes a pixel array in which a plurality of photoelectric conversion elements (pixels) are arranged so as to form a plurality of rows and a plurality of columns. Here, a photoelectric conversion device that is a specific configuration example of the light receiving device 4 will be described with reference to FIGS. 2 to 6C. A configuration of the photoelectric conversion device described below is one example. The photoelectric conversion device applicable to the light receiving device 4 is not limited thereto, and may be any device capable of realizing the function of FIG. 7 described later.

FIG. 2 is a schematic diagram illustrating an overall configuration of the photoelectric conversion device 100 according to the present embodiment. The photoelectric conversion device 100 includes a sensor substrate 11 (first substrate) and a circuit substrate 21 (second substrate) stacked on each other. The sensor substrate 11 and the circuit substrate 21 are electrically connected to each other. The sensor substrate 11 has a pixel region 12 in which a plurality of pixels 101 are arranged to form a plurality of rows and a plurality of columns. The circuit substrate 21 includes a first circuit region 22 in which a plurality of pixel signal processing units 103 are arranged to form a plurality of rows and a plurality of columns, and a second circuit region 23 arranged outside the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

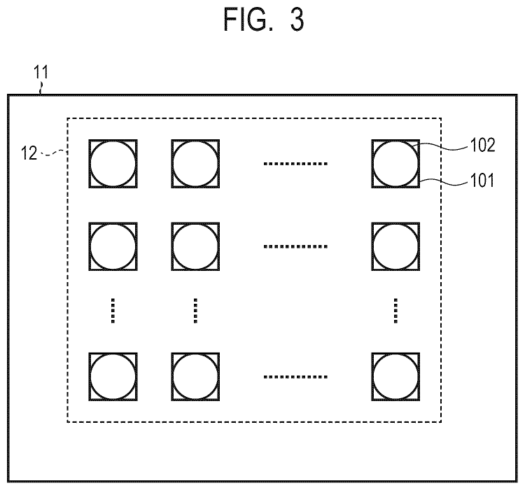

FIG. 3 is a schematic block diagram illustrating an arrangement example of the sensor substrate 11. In the pixel region 12, a plurality of pixels 101 are arranged to form a plurality of rows and a plurality of columns. Each of the plurality of pixels 101 includes a photoelectric conversion unit 102 including an avalanche photodiode (hereinafter referred to as APD) as a photoelectric conversion element in the substrate.

Of the charge pairs generated in the APD, the conductivity type corresponding to the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

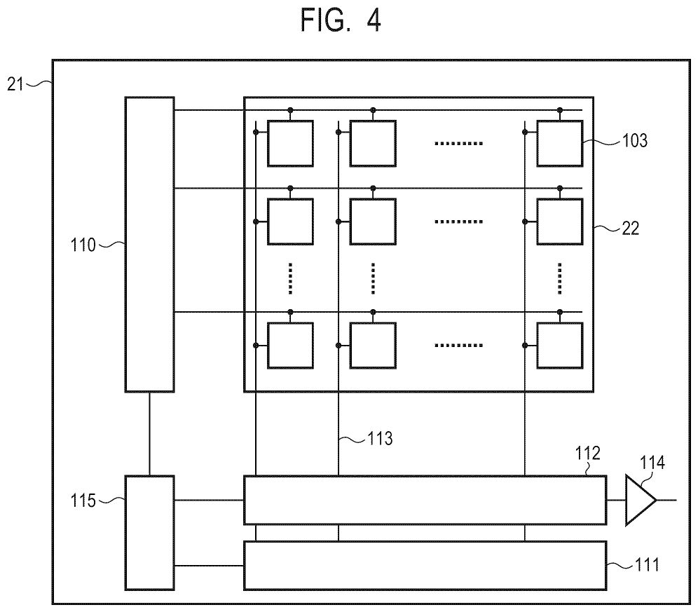

FIG. 4 is a schematic block diagram illustrating a configuration example of the circuit substrate 21. The circuit substrate 21 has the first circuit region 22 in which a plurality of pixel signal processing units 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, and a control signal generation unit 115. The plurality of photoelectric conversion units 102 illustrated in FIG. 3 and the plurality of pixel signal processing units 103 illustrated in FIG. 4 are electrically connected to each other via connection wirings provided for each pixel 101.

The control signal generation unit 115 is a control circuit that generates control signals for driving the vertical scanning circuit 110, the horizontal scanning circuit 111, and the reading circuit 112, and supplies the control signals to these units. As a result, the control signal generation unit 115 controls the driving timings and the like of each unit.

The vertical scanning circuit 110 supplies control signals to each of the plurality of pixel signal processing units 103 based on the control signal supplied from the control signal generation unit 115. The vertical scanning circuit 110 supplies control signals for each row to the pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing unit 103.

The signal output from the photoelectric conversion unit 102 of the pixel 101 is processed by the pixel signal processing unit 103. The pixel signal processing unit 103 counts the number of pulses output from the APD included in the photoelectric conversion unit 102 to acquire and hold a digital signal.

It is not always necessary to provide one pixel signal processing unit 103 for each of the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

The horizontal scanning circuit 111 supplies control signals to the reading circuit 112 based on a control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing units 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to an external storage unit or signal processing unit of the photoelectric conversion device 100 via the output circuit 114 based on the control signal supplied from the control signal generation unit 115.

The arrangement of the photoelectric conversion units 102 in the pixel region 12 may be one-dimensional. Further, the function of the pixel signal processing unit 103 does not necessarily have to be provided one by one in all the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

As illustrated in FIGS. 3 and 4, the first circuit region 22 having a plurality of pixel signal processing units 103 is arranged in a region overlapping the pixel region 12 in the plan view. In the plan view, the vertical scanning circuit 110, the horizontal scanning circuit 111, the reading circuit 112, the output circuit 114, and the control signal generation unit 115 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 (described above in FIG. 2) having the vertical scanning circuit 110, the horizontal scanning circuit 111, the reading circuit 112, the output circuit 114, and the control signal generation unit 115 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 4. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

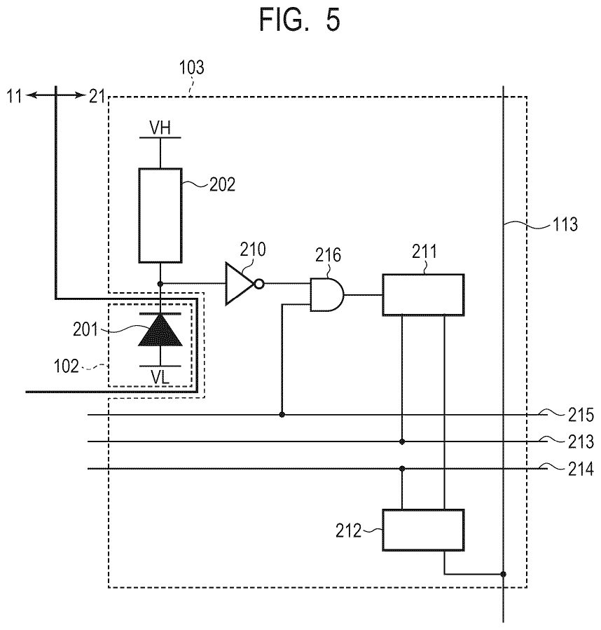

FIG. 5 is a schematic block diagram illustrating a configuration example of one pixel of the photoelectric conversion unit 102 and the pixel signal processing unit 103 according to the present embodiment. FIG. 5 schematically illustrates a more specific configuration example including a connection relationship between the photoelectric conversion unit 102 arranged in the sensor substrate 11 and the pixel signal processing unit 103 arranged in the circuit substrate 21. In FIG. 5, driving lines between the vertical scanning circuit 110 and the pixel signal processing unit 103 in FIG. 4 are illustrated as driving lines 213, 214, and 215.

The photoelectric conversion unit 102 includes an APD 201. The pixel signal processing unit 103 includes a quenching element 202, a waveform shaping unit 210, a counter circuit 211, a selection circuit 212, and a gating circuit 216. The pixel signal processing unit 103 may include at least one of the waveform shaping unit 210, the counter circuit 211, the selection circuit 212, and the gating circuit 216.

The APD 201 generates a charge corresponding to incident light by photoelectric conversion. A voltage VL (first voltage) is supplied to the anode of the APD 201. The cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is −30 V, and the voltage VH (second voltage) is 1 V. The APD 201 may operate in the linear mode or the Geiger mode. In the case of the SPAD, a potential difference becomes greater than that of the APD of the linear mode, and the effect of avalanche multiplication becomes significant, so that the SPAD is preferable.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping unit 210 shapes the potential change of the cathode of the APD 201 obtained at the time of photon detection, and outputs a pulse signal. For example, an inverter circuit is used as the waveform shaping unit 210. Although FIG. 5 illustrates an example in which one inverter is used as the waveform shaping unit 210, the waveform shaping unit 210 may be a circuit in which a plurality of inverters are connected in series, or may be another circuit having a waveform shaping effect.

The gating circuit 216 performs gating such that the pulse signal output from the waveform shaping unit 210 passes through for a predetermined period. During a period in which the pulse signal can pass through the gating circuit 216, a photon incident on the APD 201 is counted by the counter circuit 211 in the subsequent stage. Accordingly, the gating circuit 216 controls an exposure period during which a signal based on incident light is generated in the pixel 101. The period during which the pulse signal passes is controlled by a control signal supplied from the vertical scanning circuit 110 through the driving line 215. FIG. 5 illustrates an example in which one AND circuit is used as the gating circuit 216. The pulse signal and the control signal are input to two input terminals of the AND circuit. The AND circuit outputs logical conjunction of these to the counter circuit 211. Note that, the gating circuit 216 may have a circuit configuration other than the AND circuit as long as it realizes gating. Also, the waveform shaping unit 210 and the gating circuit 216 may be integrated by using a logic circuit such as a NAND circuit.

The counter circuit 211 counts the pulse signals output from the waveform shaping unit 210 via the gating circuit 216, and holds a digital signal indicating the count value. When a control signal is supplied from the vertical scanning circuit 110 through the driving line 213, the counter circuit 211 resets the held signal. The counter circuit 211 may be, for example, a one-bit counter.

The selection circuit 212 is supplied with a control signal from the vertical scanning circuit 110 illustrated in FIG. 4 through the driving line 214 illustrated in FIG. 5. In response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 5, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

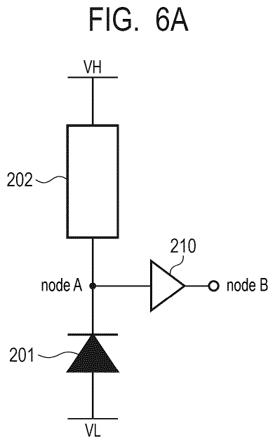

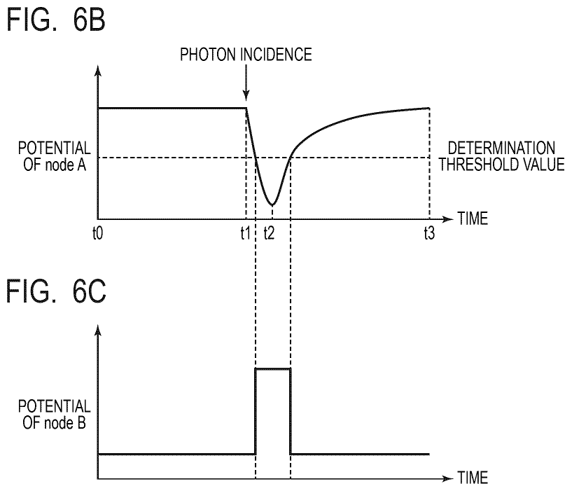

FIGS. 6A, 6B, and 6C are diagrams illustrating an operation of the APD 201 according to the present embodiment. FIG. 6A is a diagram illustrating the APD 201, the quenching element 202, and the waveform shaping unit 210 in FIG. 5. As illustrated in FIG. 6A, the connection node of the APD 201, the quenching element 202, and the input terminal of the waveform shaping unit 210 is referred to as node A. Further, as illustrated in FIG. 6A, an output side of the waveform shaping unit 210 is referred to as node B.

FIG. 6B is a graph illustrating a temporal change in the potential of node A in FIG. 6A. FIG. 6C is a graph illustrating a temporal change in the potential of node B in FIG. 6A. During a period from time t0 to time t1, the voltage VH-VL is applied to the APD 201 in FIG. 6A. When a photon enters the APD 201 at the time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

Next, the overall configuration and operation of the ranging device 1 will be described in more detail. FIG. 7 is a functional block diagram illustrating a schematic configuration example of the ranging device 1 according to the present embodiment. The ranging device 1 includes a light emitting unit 120, a light receiving unit 140, a timing generation unit 131, an exposure period control unit 132, a frequency distribution holding unit 133, a peak detection unit 134, and an output unit 135.

The light emitting unit 120 corresponds to the light emitting device 2 in FIG. 1. The light receiving unit 140 corresponds to the light receiving device 4 in FIG. 1. The timing generation unit 131, the exposure period control unit 132, the frequency distribution holding unit 133, the peak detection unit 134, and the output unit 135 correspond to the signal processing circuit 3 in FIG. 1.

The ranging device 1 according to the present embodiment performs processing in a first mode and processing in a second mode in one frame period. A second mode period in which the processing in the second mode is performed is later than a first mode period in which the processing in the first mode is performed.

The timing generation unit 131 generates a first timing that is repeated at a predetermined cycle in the first mode. In addition, the timing generation unit 131 generates a second timing that is repeated at a cycle different from that of the first timing in the second mode. The first timing and the second timing are signals indicating periodic light emission timings in the light emitting unit 120. A period between a certain first timing and the next first timing or a period between a certain second timing and the next second timing may be referred to as a micro-frame period. The micro-frame period in the first mode may be referred to as a first micro-frame period, and the micro-frame period in the second mode may be referred to as a second micro-frame period.

The timing generation unit 131 supplies the generated first timing or second timing to the light emitting unit 120 and the exposure period control unit 132. The light emitting unit 120 emits pulsed light at a light emission timing based on the first timing or the second timing. That is, in each of the first mode and the second mode, the light emitting unit 120 emits the pulsed light once in one micro-frame period at different cycles. A part of the emitted pulsed light may be reflected by the object X and may be incident on the light receiving unit 140.

The exposure period control unit 132 determines a start timing of an exposure period in the light receiving unit 140 based on the first timing in the first mode. A length of the exposure period can be appropriately set. The length of the exposure period affects the ranging resolution in the ranging device 1. That is, when the exposure period is set to be short, the distance resolution increases, and when the exposure period is set to be long, the distance resolution decreases. In addition, the exposure period control unit 132 acquires information (peak information) indicating the exposure period corresponding to the maximum value (peak) of the frequency distribution acquired in the first mode from the peak detection unit 134. In the second mode, the exposure period control unit 132 determines the start timing of the exposure period in the light receiving unit 140 with respect to the second timing based on the peak information. The exposure period control unit 132 generates a control signal for controlling the timing of the exposure period and outputs the control signal to the light receiving unit 140 and the frequency distribution holding unit 133.

One exposure period exists in one micro-frame period. After a plurality of micro-frame periods in which exposure is performed at the same start timing are ended, the start timing of the exposure period is shifted, and a plurality of micro-frame periods in which exposure is performed at the shifted start timing are started. In this specification, a plurality of micro-frame periods in which exposure is performed at the same start timing are referred to as a sub-frame period. Therefore, the exposure period control unit 132 performs control to shift the exposure period every time the sub-frame period elapses. In the first mode, the exposure period control unit 132 shifts the start timing of the exposure period by the length of the exposure period every time the sub-frame period elapses. In the second mode, the exposure period control unit 132 typically shifts the start timing of the exposure period by the length of the first micro-frame period every time the sub-frame period elapses. However, the operation in the second mode in the present embodiment is not limited thereto.

When light is incident in the exposure period, the light receiving unit 140 converts the received light into pulses of an electrical signal. The light receiving unit 140 may be, for example, the photoelectric conversion device 100 illustrated in FIGS. 2 to 6C. The output signal of the light receiving unit 140 is output to the frequency distribution holding unit 133.

The frequency distribution holding unit 133 holds the plurality of signals input from the light receiving unit 140 as a frequency distribution of the count value of the light reception signals generated by the light receiving unit 140 in each of the plurality of exposure periods. That is, the frequency distribution holding unit 133 has a function of storing, as a frequency distribution, information in which the exposure period and the count value of the light reception signals are associated with each other. A frequency distribution generated in the first mode may be referred to as a first frequency distribution, and a frequency distribution generated in the second mode may be referred to as a second frequency distribution.

The peak detection unit 134 performs peak detection processing of detecting an exposure period corresponding to the maximum value (peak) of the frequency distribution based on the frequency distribution held in the frequency distribution holding unit 133. The peak detection unit 134 outputs information (peak information) indicating the exposure period corresponding to the maximum value of the frequency distribution to the exposure period control unit 132 in the first mode, and outputs the information to the output unit 135 in the second mode.

The output unit 135 acquires peak information from the peak detection unit 134 every time one frame period elapses, and outputs the peak information to the outside of the ranging device 1 as distance information. Alternatively, the output unit 135 may acquire the frequency distribution from the frequency distribution holding unit 133 and output the frequency distribution to the outside.

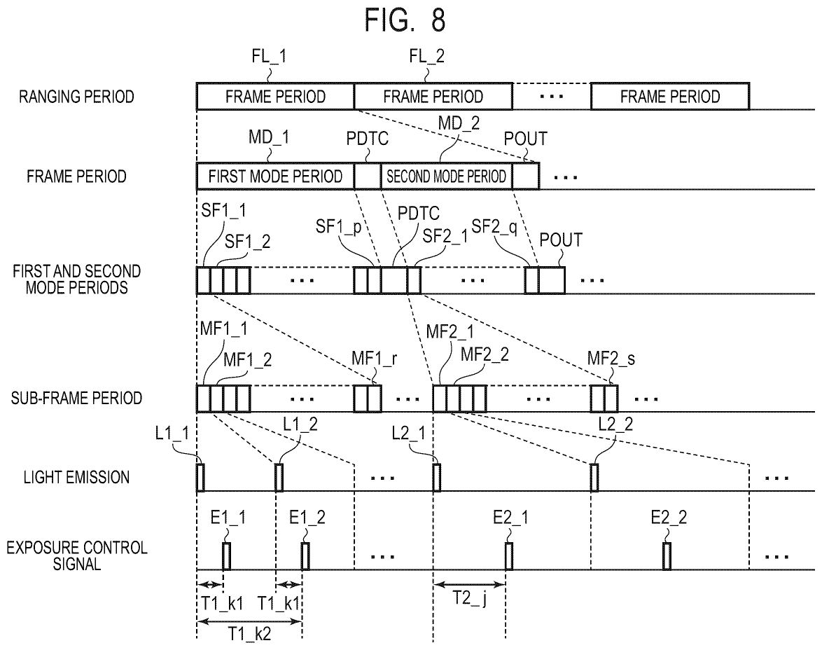

FIG. 8 is a schematic diagram for explaining the ranging frame, the first mode period, the second mode period, the sub-frame, and the micro-frame according to the present embodiment. The relationship among the ranging frame, the first mode period, the second mode period, the sub-frame, and the micro-frame will be described in more detail with reference to FIG. 8. In FIG. 8, an acquisition period of a ranging frame corresponding to one ranging result, an acquisition period of a sub-frame used to generate a ranging frame, and an acquisition period of a micro-frame used to generate a sub-frame are schematically illustrated by arranging blocks in the horizontal direction. The horizontal direction in FIG. 8 indicates the passage of time, and one block indicates an acquisition period of one ranging frame, one sub-frame, or one micro-frame. FIG. 8 illustrates a control signal for controlling the light emission period of the light emitting unit 120 and an exposure control signal for controlling the exposure period of the light receiving unit 140.

In the “ranging period” of FIG. 8, a plurality of frame periods FL_1, FL_2, . . . included in one ranging period are illustrated. The frame period FL_1 indicates a first frame period in one ranging period, and the frame period FL_2 indicates a second frame period in one ranging period. The frame period is a period in which the ranging device 1 performs ranging once and outputs a signal indicating a distance (ranging result) from the ranging device 1 to the object X to the outside. Although FIG. 8 illustrates an example of a case where the determination and output of a peak (peak detection period PDTC and peak output period POUT) from the frequency distribution are performed in the ranging device 1, this is not essential.

One ranging frame period includes a first mode period MD_1, a second mode period MD_2, a peak detection period PDTC for detecting a peak from the frequency distribution, and a peak output period POUT for outputting peak information based on the peak detected from the frequency distribution. As illustrated in the “frame period” of FIG. 8, the peak detection period PDTC is set after the completion of the first mode period MD_1 and before the start of the second mode period MD_2. The peak output period POUT is set after completion of the second mode period MD_2.

Each of the first mode period and the second mode period includes a plurality of sub-frame periods. A plurality of sub-frame periods SF1_1, SF1_2, . . . , SF1_p are illustrated in a portion corresponding to the first mode period MD_1 in the “first and second mode periods” of FIG. 8. The sub-frame period SF1_1 indicates a first sub-frame period in the first mode period MD_1, and the sub-frame period SF1_2 indicates a second sub-frame period in the first mode period MD_1. In the present embodiment, the number of sub-frame periods in the first mode period MD_1 is p (p is an integer of two or more). The sub-frame period SF1_p indicates a p-th sub-frame period in the first mode period MD_1.

Similarly, a plurality of sub-frame periods SF2_1, SF2_2, . . . , SF2_q are illustrated in a portion corresponding to the second mode period MD_2 in the “first and second mode periods” of FIG. 8. The sub-frame period SF2_1 indicates a first sub-frame period in the second mode period MD_2, and the sub-frame period SF2_2 indicates a second sub-frame period in the second mode period MD_2. In the present embodiment, the number of sub-frame periods in the second mode period MD_2 is q (q is an integer of two or more). The sub-frame period SF2_q indicates a q-th sub-frame period in the second mode period MD_2.

One sub-frame is generated from a plurality of micro-frames. In the “sub-frame period” of FIG. 8, a plurality of micro-frame periods MF1_1, MF1_2, . . . , MF1_r included in one sub-frame period in the first mode period MD_1 are illustrated. The micro-frame period MF1_1 indicates a first micro-frame period in one sub-frame period in the first mode period MD_1. The micro-frame period MF1_2 indicates a second micro-frame period in one sub-frame period in the first mode period MD_1. In the present embodiment, the number of micro-frames per sub-frame in the first mode period MD_1 is assumed to be r (r is an integer of two or more). The micro-frame period MF_r indicates an r-th micro-frame period in one sub-frame period. The number r of micro-frames corresponds to the number of times of accumulation of the light reception result in the first mode period MD_1.

Similarly, in the “sub-frame period” of FIG. 8, a plurality of micro-frame periods MF2_1, MF2_2, . . . , MF2_s included in one sub-frame period in the second mode period MD_2 are illustrated. The micro-frame period MF2_1 indicates a first micro-frame period in one sub-frame period in the second mode period MD_2. The micro-frame period MF2_2 indicates a second micro-frame period in one sub-frame period in the second mode period MD_2. In the present embodiment, the number of micro-frames per sub-frame in the second mode period MD_2 is s (s is an integer of two or more). The micro-frame period MF_s indicates an s-th micro-frame period in one sub-frame period. The number s of micro-frames corresponds to the number of times of accumulation of the light reception result in the second mode period MD_2.

The “light emission” and the “exposure control signal” in FIG. 8 indicate the light emission period of the light emitting unit 120 and the exposure control signal input to the light receiving unit 140 in one micro-frame period, respectively. The light emitting unit 120 emits light in a period in which the “light emission” is at the high level. The light emitting unit 120 emits light in a light emission period L1_1 in the micro-frame period MF1_1 in the first mode period MD_1, and emits light in a light emission period L1_2 in the micro-frame period MF1_2 in the first mode period MD_1. The start time of the light emission period L1_1 and the start time of the light emission period L1_2 correspond to the above-described first timing. In addition, the light emitting unit 120 emits light in a light emission period L2_1 in the micro-frame period MF2_1 in the second mode period MD_2, and emits light in a light emission period L2_2 in the micro-frame period MF2_2 in the second mode period MD_2. The start time of the light emission period L2_1 and the start time of the light emission period L2_2 correspond to the above-described second timing. The light emission cycle in the first mode period MD_1 is shorter than the light emission cycle in the second mode period MD_2. As a typical example, the light emission cycle of the second mode period MD_2 may be an integer multiple of the light emission cycle of the first mode period MD_1, but the ratio of the light emission cycle of the second mode period MD_2 to the light emission cycle of the first mode period MD_1 is not limited to an integer.

The light receiving unit 140 detects incident light when light is incident in an exposure period in which the “exposure control signal” output from the exposure period control unit 132 is at the high level. In the micro-frame period MF1_1 in the first mode period MD_1, incident light is detected in an exposure period E1_1. In the micro-frame period MF1_2 in the first mode period MD_1, incident light is detected in an exposure period E1_2. In the micro-frame period MF2_1 in the second mode period MD_2, the incident light is detected in an exposure period E2_1. In the micro-frame period MF2_2 in the second mode period MD_2, the incident light is detected in an exposure period E2_2.

In the first mode period MD_1, a period T1_k1 from the start of the light emission period L1_1 to the start of the exposure period E1_1 and a period T1_k2 from the start of the light emission period L1_1 to the start of the exposure period E1_2 are flight periods of light from light emission in the light emission period L1_1 to light reception. That is, in an exposure period E1_n in a micro-frame period MF1_n (n is an integer of two or more), light emitted in a light emission period L1_n and light emitted in a light emission period L1_(n−1) are detected. Thus, it is detected whether the object X is present at a distance corresponding to the period T1_k1 and the period T1_k2. In this example, the time interval between the exposure period E1_n and a light emission period L1_(n−2) is sufficiently long, and the reflected light generated by the reflection of the light emitted in the light emission period L1_(n−2) on the object X does not affect the detection in the exposure period E1_n. Further, k is a number of a corresponding sub-frame period, and is an integer from one to p.

In the second mode period MD_2, a period T2_j from the start of the light emission period L2_1 to the start of the exposure period E2_1 is a flight period of light from light emission in the light emission period L2_1 to light reception. That is, in an exposure period E2_m of a micro-frame period MF2_m (m is an integer of two or more), light emitted in a light emission period L2_m is detected. Thus, it is detected whether the object X is present at a distance corresponding to the period T2_j. Note that j is a number of a corresponding sub-frame period, and is an integer from one to q.

In the first mode period MD_1, reading of the received light data (acquisition of micro-frames) is performed r times in one sub-frame period. When a photon is detected one or more times within one micro-frame period, the light receiving unit 140 outputs “1” as light reception data. By accumulating r micro-frames acquired in one sub-frame period, data indicating the number of micro-frames in which a photon is detected is generated.

In each of the plurality of sub-frame periods SF1_1, SF1_2, . . . , SF1_p, the lengths of the periods T1_11, T1_21, . . . , T1_p1 are different from each other and the lengths of the periods T1_12, T1_22, . . . , T1_p2 are different from each other. Accordingly, in each of the plurality of sub-frame periods SF1_1, SF1_2, . . . , SF1_p, the frequency distribution of the light reception count values at different distances is acquired. In the peak detection period PDTC, the peak of the frequency distribution is detected by obtaining the maximum value of the light reception count value of each of the sub-frame periods SF1_1, SF1_2, . . . , SF1_p. One of the lengths of the period T1_k1 and the period T1_k2 corresponding to the peak is proportional to the distance from the ranging device 1 to the object X.

Similarly, in the second mode period MD_2, reading of the received light data (acquisition of micro-frames) is performed s times in one sub-frame period. When a photon is detected one or more times within one micro-frame period, the light receiving unit 140 outputs “1” as light reception data. By accumulating the s micro-frames acquired in one sub-frame period, data indicating the number of micro-frames in which a photon is detected is generated.

In each of the plurality of sub-frame periods SF2_1, SF2_2, . . . , SF2_q, the lengths of the periods T2_1, T2_2, . . . , T2_q are different from each other. In the example of the present embodiment, in the first mode period MD_1, it is detected that the object X is present at a distance corresponding to one of the period T1_k1 and the period T1_k2. Therefore, in the second mode period MD_2, the number of sub-frames q is set to two, and measurement for determining which distance corresponding to the period T1_k1 or the period T1_k2 the object X is present is performed. That is, the measurement is performed in a state where the exposure period E2_1 is set at the timing of the period T1_k1 in the sub-frame period SF2_1 and the exposure period E2_2 is set at the timing of the period T1_k2 in the sub-frame period SF2_2.

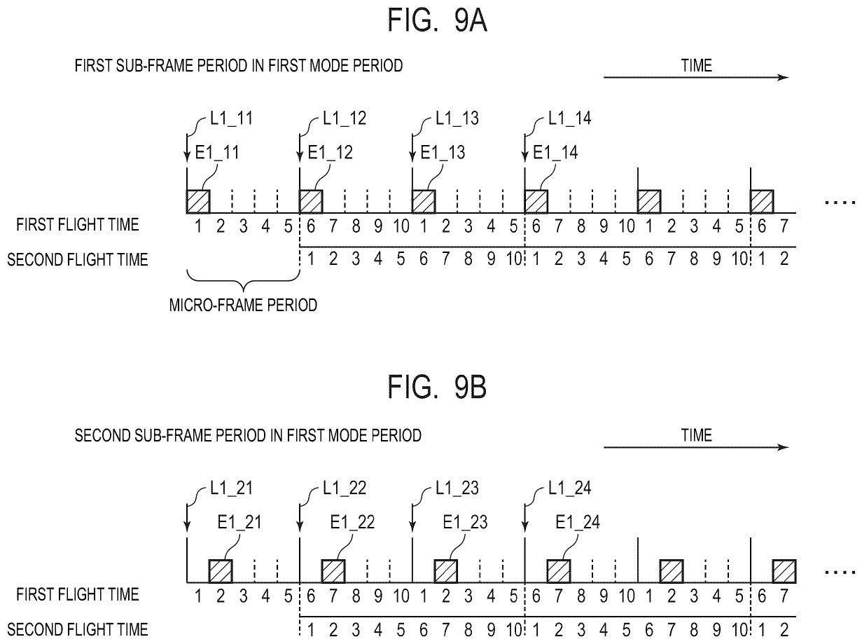

Next, an operation method of the present embodiment will be described with reference to FIGS. 9A to 12. In the following description, a measurement method is exemplified in which the period corresponding to the ranging range is divided into 10 periods to determine which of the 10 periods corresponds to the distance at which the object X exists. However, this method is merely an example in the present embodiment, and is not limited thereto.

FIGS. 9A and 9B are timing charts illustrating the relationship between the light emission timing of the light emitting unit 120 and the exposure period of the light receiving unit 140 in the first mode period MD_1. FIG. 9A is a timing chart of the first sub-frame period SF1_1 in the first mode period MD_1. FIG. 9A schematically illustrates light emission periods L1_11, L1_12, L1_13, and L1_14 and exposure periods E1_11, E1_12, E1_13, and E1_14 in the first sub-frame period SF1_1. In FIG. 9A, a numerical value proportional to the flight time of light between light emission in the light emission periods L1_11 and L1_13 and light reception is illustrated as a “first flight time”. Further, in FIG. 9A, a numerical value proportional to the flight time of light between light emission in the light emission periods L1_12 and L1_14 and light reception is illustrated as a “second flight time”. These flight times are proportional to the distance from the ranging device 1 to the object X. The exposure period E1_11 is a period in which reflected light emitted in the light emission period L1_11 and having a flight time of “1” can be received. The exposure period E1_12 is a period in which reflected light emitted in the light emission period L1_12 and having a flight time of “1” and reflected light emitted in the light emission period L1_11 and having a flight time of “6” can be received. Similarly, the exposure period E1_13 is a period in which reflected light emitted in the light emission period L1_13 and having a flight time of “1” and reflected light emitted in the light emission period L1_12 and having a flight time of “6” can be received.

FIG. 9B is a timing chart of the second sub-frame period SF1_2 in the first mode period MD_1. FIG. 9B schematically illustrates light emission periods L1_21, L1_22, L1_23, and L1_24 and exposure periods E1_21, E1_22, E1_23, and E1_24 in the sub-frame period SF1_2. The notations “first flight time” and “second flight time” are the same as in FIG. 9A. The exposure period E1_21 is a period in which reflected light emitted in the light emission period L1_21 and having a flight time of “2” can be received. The exposure period E1_22 is a period in which reflected light emitted in the light emission period L1_22 and having a flight time of “2” and reflected light emitted in the light emission period L1_21 and having a flight time of “7” can be received. Similarly, the exposure period E1_23 is a period in which reflected light emitted in the light emission period L1_23 and having a flight time of “2” and reflected light emitted in the light emission period L1_22 and having a flight time of “7” can be received.

In this example, the first mode period MD_1 includes five sub-frame periods SF1_1 to SF1_5. The sub-frame periods SF1_3 to SF1_5 are obtained by shifting the exposure periods of the above-described sub-frame period SF1_1 or SF1_2, and others are the same, and thus description thereof is omitted.

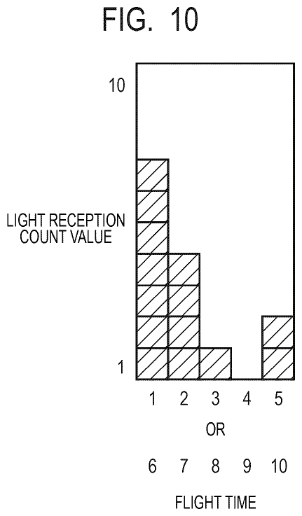

FIG. 10 is a schematic diagram illustrating a frequency distribution acquired in the first mode period MD_1 by the ranging method according to the present embodiment. The horizontal axis of FIG. 10 is the value of the flight time corresponding to the position of the exposure period described above. As described above, the flight times “1” and “6”, the flight times “2” and “7”, the flight times “3” and “8”, the flight times “4” and “9”, and the flight times “5” and “10” are measured in a mixed state. Therefore, the horizontal axis in FIG. 10 is expressed as “1” to “5” or “6” to “10”. The vertical axis of FIG. 10 represents the number of micro-frames in which light is detected in each exposure period, that is, the light reception count value. FIG. 10 illustrates an example in which the number of micro-frames per sub-frame is 10 in the operation of the first mode period MD_1 described above, and thus the maximum value of the vertical axis is 10. In the example illustrated in FIG. 10, since the light reception count value in the exposure period in which the flight time is “1” or “6” is the maximum, the distance from the ranging device 1 to the object X is either the distance corresponding to the flight time “1” or the distance corresponding to the flight time “6”.

Next, the processing in the second mode period MD_2 will be described. In this example, in the measurement in the first mode period MD_1 described above, peak information indicating that the light reception count value in the exposure period in which the flight time is “1” or “6” is the maximum is obtained as illustrated in FIG. 10. Therefore, in the second mode period MD_2, the measurement in the sub-frame period SF2_1 in which the exposure period corresponding to the flight time of “1” is set and the measurement in the sub-frame period SF2_2 in which the exposure period corresponding to the flight time of “6” is set are performed.

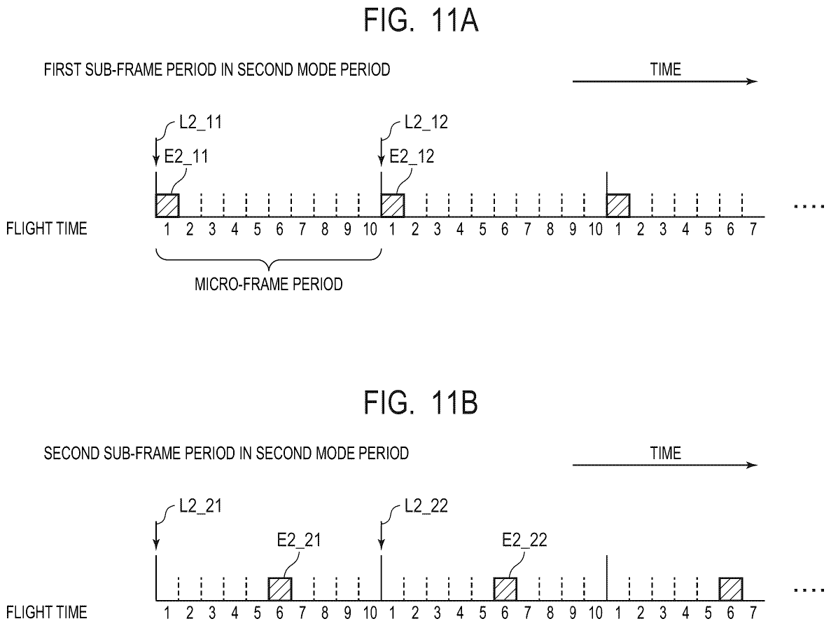

FIGS. 11A and 11B are timing charts illustrating the relationship between the light emission timing of the light emitting unit 120 and the exposure period of the light receiving unit 140 in the second mode period MD_2. FIG. 11A is a timing chart of the first sub-frame period SF2_1 in the second mode period MD_2. FIG. 11A schematically illustrates light emission periods L2_11 and L2_12 and exposure periods E2_11 and E2_12 in the first sub-frame period SF2_1. Further, in FIG. 11A, a numerical value proportional to a flight time of light between light emission in the light emission periods L2_11 and L2_12 and light reception is illustrated as a “flight time”. The exposure period E2_11 is a period in which reflected light emitted in the light emission period L2_11 and having a flight time of “1” can be received. The exposure period E2_12 is a period in which reflected light emitted in the light emission period L2_12 and having a flight time of “1” can be received. The time width of the exposure period of the second mode period MD_2 is set to be equal to the time width of the exposure period of the first mode period MD_1.

FIG. 11B is a timing chart of the second sub-frame period SF2_2 in the second mode period MD_2. FIG. 11B schematically illustrates light emission periods L2_21 and L2_22 and exposure periods E2_21 and E2_22 in the sub-frame period SF2_2. The exposure period E2_21 is a period in which reflected light emitted in the light emission period L2_21 and having a flight time of “6” can be received. The exposure period E2_22 is a period in which reflected light emitted in the light emission period L2_22 and having a flight time of “6” can be received.

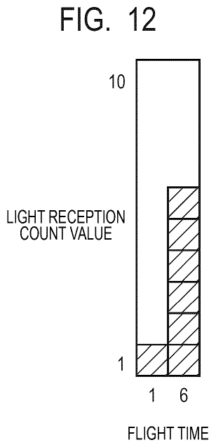

FIG. 12 is a schematic diagram illustrating a frequency distribution acquired in the second mode period MD_2 by the ranging method according to the present embodiment. FIG. 12 illustrates an example in which the number of micro-frames per sub-frame is 10 in the operation of the second mode period MD_2 described above, and thus the maximum value of the vertical axis is 10. In the example illustrated in FIG. 12, since the light reception count value in the exposure period in which the flight time is “6” is the maximum, the distance from the ranging device 1 to the object X is a distance corresponding to the flight time “6”.

In the examples of FIGS. 10 and 12, the number of micro-frames per one sub-frame in the first mode period MD_1 and the second mode period MD_2 is both 10, but is not limited thereto. For example, the number of micro-frames per one sub-frame in the second mode period MD_2 may be less than the number of micro-frames per one sub-frame in the first mode period MD_1. That is, the timing generation unit 131 may set the number of times of generation of the second timing in one sub-frame period to be less than the number of times of generation of the first timing in one sub-frame period. Since the second mode period MD_2 is a measurement for determining which of the light reception count values in the distant exposure periods is the maximum, erroneous determination due to noise is less likely to occur than in the case of comparing the light reception count values in the adjacent exposure periods as in the first mode period MD_1. Therefore, by setting the number of micro-frames per sub-frame in the second mode period MD_2 to be less than that in the first mode period MD_1, it is possible to reduce the ranging time without significantly lowering the ranging accuracy.

As described above, the ranging device 1 of the present embodiment operates in the first mode and the second mode in which the light emission intervals are different from each other. The light emission interval (cycle of the second timing) in the second mode is longer than the light emission interval (cycle of the first timing) in the first mode. In the first mode, one cycle of the light emission timing is divided into a plurality of periods, each period is set to an exposure period, and the light reception count value is measured. Then, the ranging device 1 determines the timing of the exposure period in the second mode period MD_2 based on the frequency distribution acquired in the first mode period MD_1. With such a configuration, the total number of sub-frames in the first mode period MD_1 and the second mode period MD_2 can be reduced as compared with a case where measurement is performed in each exposure period in one mode. Therefore, according to the present embodiment, the ranging device 1 capable of reducing the measurement time is provided.

The reduction of the measurement time will be described more specifically. For example, in the example of FIGS. 9A to 12, since the measurement corresponding to two distances can be collectively performed in one exposure period in the first mode period MD_1, the number of sub-frames is reduced by half. In addition, in the second mode period MD_2, the number of sub-frames is reduced to two. As described above, in the present embodiment, although two-stage measurement of the first mode period MD_1 and the second mode period MD_2 is required, the total number of sub-frames is reduced and thus the measurement time per one ranging frame is reduced.

Note that the configuration and operation of the ranging device 1 of the present embodiment are merely examples, and they are not limited thereto. Some modified examples of the configuration of each unit in the ranging device 1 will be described.

The peak detection processing in the peak detection unit 134 is not limited to detecting one exposure period corresponding to the maximum value of the light reception count value of the frequency distribution. For example, the peak detection unit 134 may detect a plurality of exposure periods in descending order of the light reception count value of the frequency distribution. In addition, the peak detection unit 134 may detect an exposure period in which the light reception count value of the frequency distribution exceeds a threshold value. Here, the magnitude of the threshold value may be common for each exposure period or may be different for each exposure period. In this configuration, the peak detection unit 134 may detect one or a plurality of exposure periods in descending order of the light reception count value from among a plurality of exposure periods in which the light reception count value of the frequency distribution exceeds the threshold value.

When the peak detection unit 134 detects a plurality of exposure periods in the first mode period MD_1 as in some examples described above, the exposure period control unit 132 determines the exposure period of the second mode period based on the plurality of exposure periods detected. On the other hand, when the peak detection unit 134 does not detect the exposure period in the first mode period MD_1, the exposure period control unit 132 may perform control so as not to perform the operation in the second mode period MD_2. Alternatively, in this case, the peak detection unit 134 or the exposure period control unit 132 may output a signal indicating that there is no peak to the timing generation unit 131 to stop the output operation of the second timing. In this case, the operations of the light emitting unit 120 and the exposure period control unit 132 in the second mode period MD_2 are stopped.

The frequency distribution holding unit 133 may individually hold the first frequency distribution acquired in the first mode period MD_1 and the second frequency distribution acquired in the second mode period MD_2. On the other hand, the frequency distribution holding unit 133 may overwrite the first frequency distribution acquired in the first mode period MD_1 when acquiring the second frequency distribution in the second mode period MD_2. In this case, the storage capacity of the frequency distribution holding unit 133 can be reduced.

The timing generation unit 131 may set the cycle of the second timing to be three times the cycle of the first timing or may set the cycle to be an integer multiple greater than three times the cycle of the first timing. The cycle of the second timing is not limited to an integer multiple of the cycle of the first timing. When the cycle of the second timing is three times the cycle of the first timing, typically, the number of sub-frame periods in the second mode period MD_2 is set to three, and measurement is performed in three different exposure periods in these three sub-frame periods.

In addition, a period of one cycle of the second timing of the second mode period MD_2 may include a ranging period in which an exposure period is set and a non-ranging period in which an exposure period is not set. The non-ranging period is arranged in a period between a ranging period of one cycle of the second timing and light emission of the next one cycle. Since the non-ranging period is arranged, it is possible to reduce the influence of noise generated when the reflected light from the object X that is farther than the set ranging range is received in the exposure period of the next cycle. When the period of one cycle of the second timing includes the non-ranging range, for example, the cycle of the second timing may be set to three times the cycle of the first timing, and the number of sub-frame periods in the second mode period MD_2 may be set to two.

### Second Embodiment

In the present embodiment, a configuration example in a case where the frequency distribution holding unit 133 and the peak detection unit 134 are arranged in a device outside the photoelectric conversion device will be described. In the present embodiment, description of elements common to those of the first embodiment may be omitted or simplified.

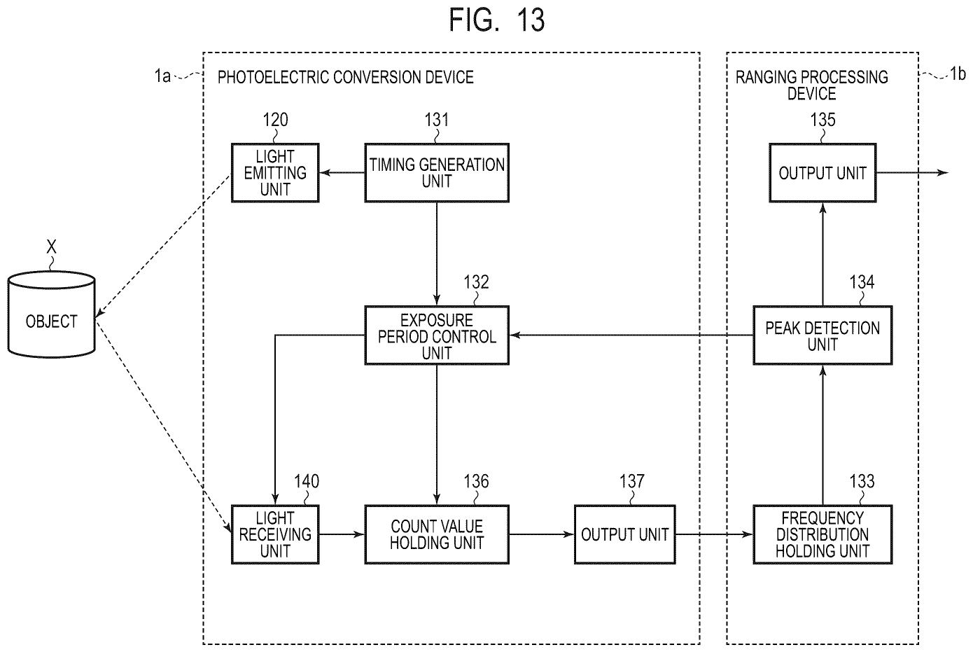

FIG. 13 is a functional block diagram illustrating a schematic configuration example of the photoelectric conversion device and the ranging processing device according to the present embodiment. In the present embodiment, a system corresponding to the ranging device 1 of the first embodiment is constituted by two devices, that is, a photoelectric conversion device 1a and a ranging processing device 1b. The photoelectric conversion device 1a includes a light emitting unit 120, a light receiving unit 140, a timing generation unit 131, an exposure period control unit 132, a count value holding unit 136, and an output unit 137. The ranging processing device 1b includes a frequency distribution holding unit 133, a peak detection unit 134, and an output unit 135. As described above, in the present embodiment, the frequency distribution holding unit 133 and the peak detection unit 134 are arranged in the ranging processing device 1b outside the photoelectric conversion device 1a. The photoelectric conversion device 1a and the ranging processing device 1b cooperate to constitute a ranging system that performs the same ranging as the ranging device 1 of the first embodiment.

The exposure period control unit 132 acquires information (peak information) indicating the exposure period corresponding to the peak of the frequency distribution acquired in the first mode from the peak detection unit 134 arranged in the ranging processing device 1b outside the photoelectric conversion device 1a. In the second mode, the exposure period control unit 132 determines the start timing of the exposure period in the light receiving unit 140 with respect to the second timing based on the peak information. The exposure period control unit 132 outputs a control signal indicating the exposure period to the light receiving unit 140 and the count value holding unit 136. Alternatively, the exposure period control unit 132 may acquire the exposure period setting information based on the peak information from the peak detection unit 134 and generate the control signal based on the exposure period setting information.

The count value holding unit 136 counts the light reception signal output from the light receiving unit 140 and holds the count value as a light reception count value of incident light. The output unit 137 outputs the light reception count value held in the count value holding unit 136 to the ranging processing device 1b outside the photoelectric conversion device 1a every time the sub-frame period elapses. The frequency distribution holding unit 133 of the ranging processing device 1b generates a frequency distribution based on the light reception count value of each sub-frame period. The processing after the generation of the frequency distribution is the same as in the first embodiment.

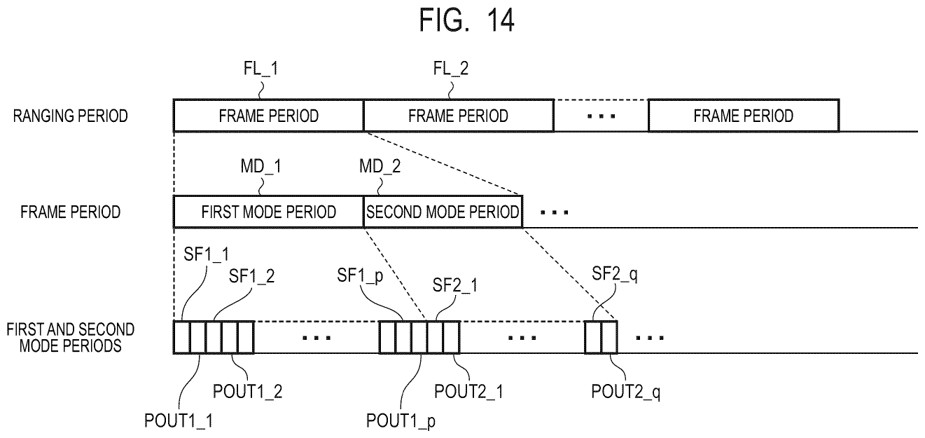

FIG. 14 is a schematic diagram for explaining a ranging frame according to the present embodiment and sub-frames in a first mode period and a second mode period. Since the relationship between the sub-frame and the micro-frame is the same as in the first embodiment, the description thereof will be omitted. In the “ranging period” of FIG. 14, a plurality of frame periods are illustrated as in the first embodiment.

One ranging frame period includes a first mode period MD_1 and a second mode period MD_2. In each of the first mode period MD_1 and the second mode period MD_2, a sub-frame period and an output period of the light reception count value are alternately repeated. An output period POUT1_1 in the first mode period MD_1 is a period in which the light reception count value of a sub-frame period SF1_1 is output to the outside. An output period POUT1_2 is a period in which the light reception count value of a sub-frame period SF1_2 is output to the outside. An output period POUT1_p is a period in which the light reception count value of a sub-frame period SF1_p is output to the outside. As described above, the output unit 137 sequentially outputs the light reception count values obtained in all the sub-frame periods to the outside. The same applies to the second mode period, and for example, an output period POUT2_1 in the second mode period MD_2 is a period in which the light reception count value of a sub-frame period SF2_1 is output to the outside.

As described above, in the present embodiment, although the frequency distribution holding unit 133 and the peak detection unit 134 are arranged in the ranging processing device 1b outside the photoelectric conversion device 1a, the same ranging as in the ranging device 1 of the first embodiment can be performed. Therefore, according to the present embodiment, the photoelectric conversion device 1a capable of reducing the measurement time is provided.

Two count value holding units 136 may be provided. In this case, the operation in the sub-frame period and the operation in the output period of the light reception count value can be performed in parallel, and the measurement time can be further reduced.

### Third Embodiment

In the first embodiment, the time width of the exposure period of the second mode period MD_2 is set to be equal to the time width of the exposure period of the first mode period MD_1. On the other hand, in the present embodiment, an operation when the time width of the exposure period of the second mode period MD_2 is set to be shorter than the time width of the exposure period of the first mode period MD_1 will be described. In the present embodiment, description of elements common to those of the first embodiment may be omitted or simplified.

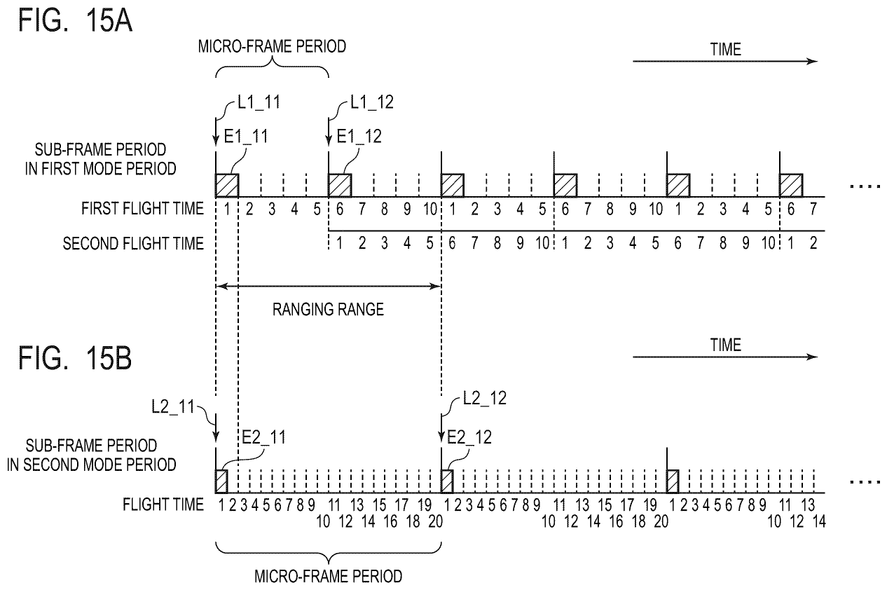

FIGS. 15A and 15B are timing charts illustrating the relationship between the sub-frame period in the first mode period MD_1 and the sub-frame period in the second mode period MD_2 according to the present embodiment. FIG. 15A illustrates a sub-frame period in the first mode period MD_1, in which a period corresponding to a ranging range is divided into 10 periods as in the first embodiment. FIG. 15B illustrates a sub-frame period in the second mode period MD_2, in which a period corresponding to the ranging range is divided into 20 periods. Therefore, in the present embodiment, the time width of the exposure period of the second mode period MD_2 is half the time width of the exposure period of the first mode period MD_1.

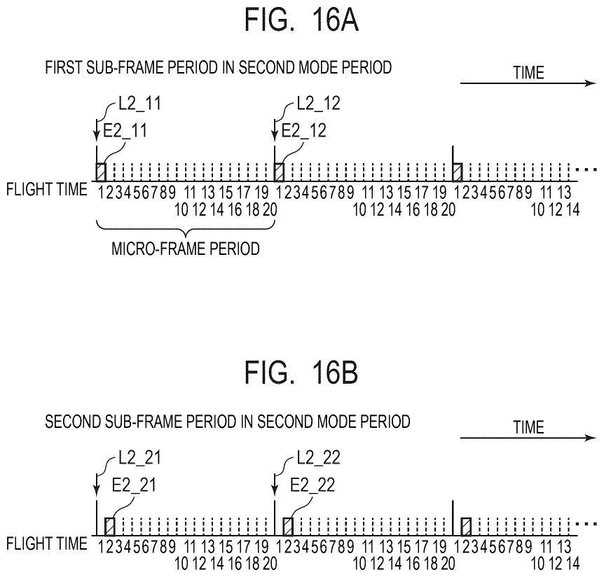

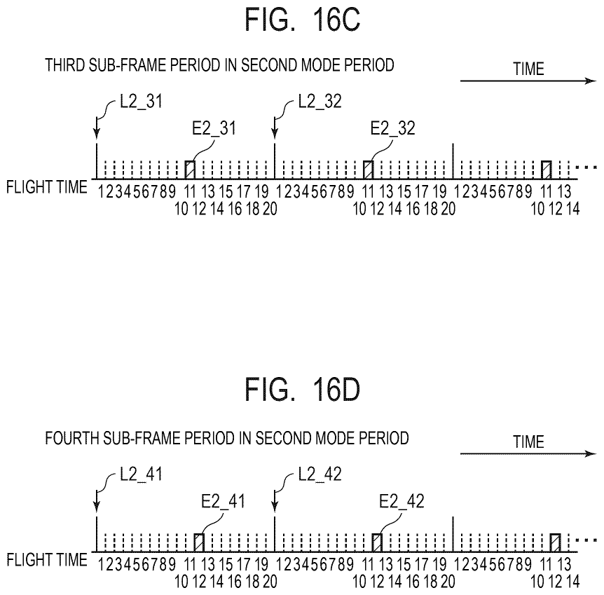

FIGS. 16A to 16D are timing charts illustrating the relationship between the light emission timing of the light emitting unit 120 and the exposure period of the light receiving unit 140 in the second mode period MD_2 according to the present embodiment. In the present embodiment, since the operation in the first mode period MD_1 is the same as that in the first embodiment, the description of the first mode period MD_1 will be omitted.

FIG. 16A schematically illustrates light emission periods L2_11 and L2_12 and exposure periods E2_11 and E2_12 in a first sub-frame period SF2_1. The exposure period E2_11 is a period in which reflected light emitted in the light emission period L2_11 and having a flight time of “1” can be received. The exposure period E2_12 is a period in which reflected light emitted in the light emission period L2_12 and having a flight time of “1” can be received.

FIG. 16B schematically illustrates light emission periods L2_21 and L2_22 and exposure periods E2_21 and E2_22 in a second sub-frame period SF2_2. The exposure period E2_21 is a period in which reflected light emitted in the light emission period L2_21 and having a flight time of “2” can be received. The exposure period E2_22 is a period in which reflected light emitted in the light emission period L2_22 and having a flight time of “2” can be received. FIGS. 16A and 16B respectively illustrate two sub-frame periods in the second mode period MD_2 corresponding to the distance of “1” in the exposure period of the first mode period MD_1. That is, one exposure period E1_11 in the first mode period MD_1 corresponds to two exposure periods E2_11 and E2_21 in the second mode period MD_2.

FIG. 16C schematically illustrates light emission periods L2_31 and L2_32 and exposure periods E2_31 and E2_32 in a third sub-frame period SF2_3. The exposure period E2_31 is a period in which reflected light emitted in the light emission period L2_31 and having a flight time of “11” can be received. The exposure period E2_32 is a period in which reflected light emitted in the light emission period L2_32 and having a flight time of “11” can be received.

FIG. 16D schematically illustrates light emission periods L2_41 and L2_42 and exposure periods E2_41 and E2_42 in a fourth sub-frame period SF2_4. The exposure period E2_41 is a period in which reflected light emitted in the light emission period L2_41 and having a flight time of “12” can be received. The exposure period E2_42 is a period in which reflected light emitted in the light emission period L2_42 and having a flight time of “12” can be received. FIGS. 16C and 16D respectively illustrate two sub-frame periods in the second mode period MD_2 corresponding to the distance of “6” in the exposure period of the first mode period MD_1. That is, one exposure period E1_12 in the first mode period MD_1 corresponds to two exposure periods E2_31 and E2_41 in the second mode period MD_2.

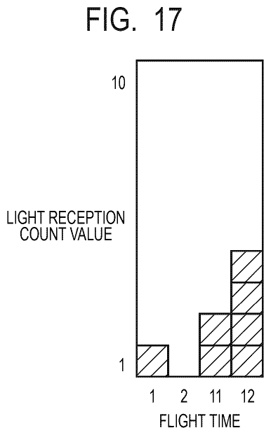

FIG. 17 is a schematic diagram illustrating a frequency distribution acquired in the second mode period MD_2 by the ranging method according to the present embodiment. In the example illustrated in FIG. 17, since the light reception count value in the exposure period in which the flight time is “12” is the maximum, the distance from the ranging device 1 to the object X is a distance corresponding to the flight time of “12”.

As described above, in the present embodiment, the measurement is performed in the four sub-frame periods SF2_1 to SF2_4. The time width of the exposure period corresponding to the sub-frame periods SF2_1 to SF2_4 is half the time width of the exposure period of the first mode period MD_1. Therefore, since the time width of the exposure period in acquiring the frequency distribution for ranging can be shortened, the distance resolution of ranging can be improved.

As described above, in the ranging device 1 of the present embodiment, although the operation in the first mode period MD_1 is the same as that in the first embodiment, the time width of the exposure period in the second mode period MD_2 is set to be shorter than the time width of the exposure period in the first mode period MD_1. Accordingly, in addition to obtaining the same effect as that of the first embodiment, the distance resolution of the ranging can be improved without increasing the measurement time of the first mode period MD_1.

Note that the configuration and operation of the ranging device 1 of the present embodiment are merely examples, and they are not limited thereto. For example, the time width of the exposure period of the first mode period MD_1 may be three times the time width of the exposure period of the second mode period MD_2, may be an integer multiple greater than three, or may not be an integer multiple.

### Fourth Embodiment

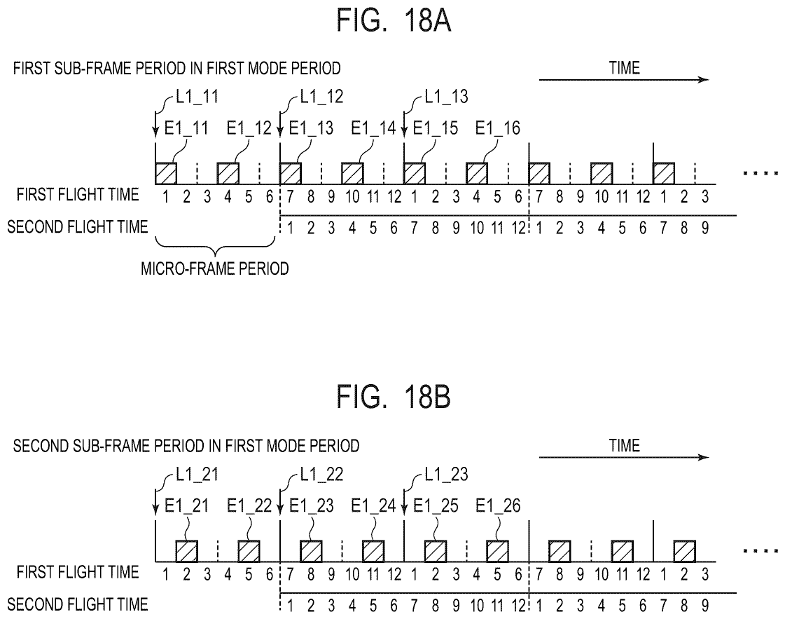

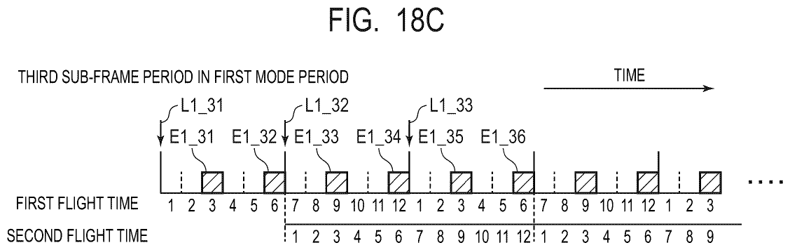

In the present embodiment, an operation when a plurality of exposure periods are arranged in one micro-frame period in the first mode period MD_1 will be described with reference to FIGS. 18A to 21. In the present embodiment, description of elements common to those of the first embodiment may be omitted or simplified.

In the following description, a measurement method is exemplified in which a period corresponding to a ranging range is divided into 12 periods, and a distance corresponding to which period of the 12 periods the object X is present is determined. However, this method is merely an example in the present embodiment, and is not limited thereto.

FIGS. 18A to 18C are timing charts illustrating the relationship between the light emission timing of the light emitting unit 120 and the exposure period of the light receiving unit 140 in the first mode period MD_1 in the present embodiment. FIG. 18A is a timing chart of the first sub-frame period SF1_1 in the first mode period MD_1. FIG. 18A schematically illustrates light emission periods L1_11, L1_12, and L1_13 and exposure periods E1_11, E1_12, E1_13, E1_14, E1_15, and E1_16 in the first sub-frame period SF1_1. In FIG. 18A, a numerical value proportional to the flight time of light between light emission and light reception in the light emission periods L1_11 and L1_13 is illustrated as a “first flight time”. In FIG. 18A, a numerical value proportional to the flight time of light between light emission and light reception in the light emission period L1_12 is illustrated as a “second flight time”. In the present embodiment, two exposure periods are arranged in one micro-frame period. For example, the exposure period E1_13 is a period in which reflected light emitted in the light emission period L1_12 and having a flight time of “1” and reflected light emitted in the light emission period L1_11 and having a flight time of “7” can be received. The exposure period E1_14 is a period in which the reflected light emitted in the light emission period L1_12 and having the flight time of “4” and the reflected light emitted in the light emission period L1_11 and having the flight time of “10” can be received.

FIG. 18B is a timing chart of the second sub-frame period SF1_2 in the first mode period MD_1. As in the first embodiment, all the exposure periods are shifted by one exposure period with respect to the sub-frame period SF1_1. FIG. 18C is a timing chart of the third sub-frame period SF1_3 in the first mode period MD_1. Similarly, all the exposure periods are shifted by one exposure period with respect to the second sub-frame period SF1_2. The second sub-frame period SF1_2 and the third sub-frame period SF1_3 are similar to the first sub-frame period SF1_1 except that the exposure period is shifted, and thus description thereof is omitted.

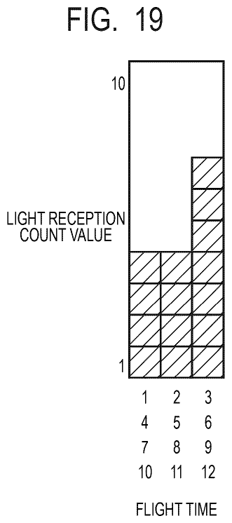

FIG. 19 is a schematic diagram illustrating a frequency distribution acquired in the first mode period MD_1 by the ranging method according to the present embodiment. The horizontal axis of FIG. 19 is the value of the flight time corresponding to the position of the exposure period described above. As described above, since the flight times “1”, “4”, “7”, and “10”, the flight times “2”, “5”, “8”, and “11”, and the flight times “3”, “6”, “9”, and “12” are measured in a mixed state, a plurality of values are also indicated on the horizontal axis of FIG. 19. The vertical axis in FIG. 19 represents the number of micro-frames in which light is detected in each exposure period, that is, the light reception count value. FIG. 19 illustrates an example in which the number of micro-frames per sub-frame is 10 in the operation of the first mode period MD_1 described above, and thus the maximum value of the vertical axis is 10. In the example illustrated in FIG. 19, since the light reception count value in the exposure period in which the flight time is “3”, “6”, “9”, or “12” is the maximum, the distance from the ranging device 1 to the object X is a distance corresponding to one of the flight times “3”, “6”, “9”, and “12”.

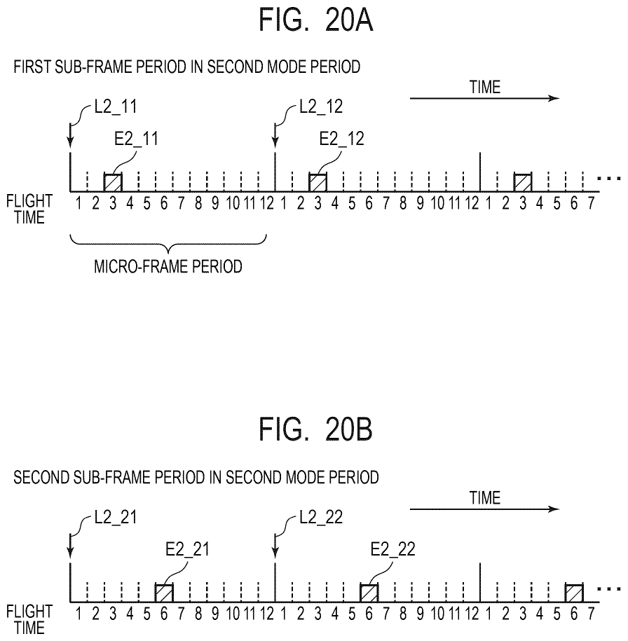

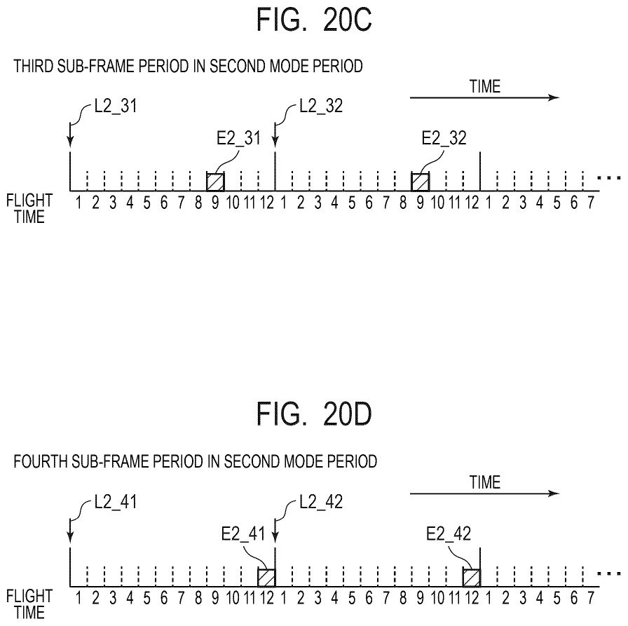

Next, the processing in the second mode period MD_2 will be described. In this example, in the measurement in the first mode period MD_1 described above, peak information indicating that the light reception count value in the exposure period in which the flight time is “3”, “6”, “9”, or “12” is the maximum is obtained as illustrated in FIG. 19. Therefore, in the second mode period MD_2, the measurement is performed in the sub-frame periods SF2_1, SF2_2, SF2_3, and SF2_4 in which the exposure periods corresponding to the flight times “3”, “6”, “9”, and “12” are set, respectively. FIGS. 20A to 20D are timing charts illustrating the relationship between the light emission timing of the light emitting unit 120 and the exposure period of the light receiving unit 140 in the second mode period MD_2.

FIG. 20A schematically illustrates light emission periods L2_11 and L2_12 and exposure periods E2_11 and E2_12 in a first sub-frame period SF2_1. The exposure period E2_11 is a period in which reflected light emitted in the light emission period L2_11 and having a flight time of “3” can be received. The exposure period E2_12 is a period in which reflected light emitted in the light emission period L2_12 and having a flight time of “3” can be received.

FIG. 20B schematically illustrates light emission periods L2_21 and L2_22 and exposure periods E2_21 and E2_22 in a second sub-frame period SF2_2. The exposure period E2_21 is a period in which reflected light emitted in the light emission period L2_21 and having a flight time of “6” can be received. The exposure period E2_22 is a period in which reflected light emitted in the light emission period L2_22 and having a flight time of “6” can be received.

FIG. 20C schematically illustrates light emission periods L2_31 and L2_32 and exposure periods E2_31 and E2_32 in a third sub-frame period SF2_3. The exposure period E2_31 is a period in which reflected light emitted in the light emission period L2_31 and having a flight time of “9” can be received. The exposure period E2_32 is a period in which reflected light emitted in the light emission period L2_32 and having a flight time of “9” can be received.

FIG. 20D schematically illustrates light emission periods L2_41 and L2_42 and exposure periods E2_41 and E2_42 in a fourth sub-frame period SF2_4. The exposure period E2_41 is a period in which reflected light emitted in the light emission period L2_41 and having a flight time of “12” can be received. The exposure period E2_42 is a period in which reflected light emitted in the light emission period L2_42 and having a flight time of “12” can be received.

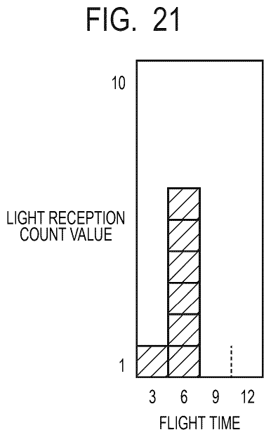

FIG. 21 is a schematic diagram illustrating a frequency distribution acquired in the second mode period MD_2 acquired by the ranging method according to the present embodiment. FIG. 21 illustrates an example in which the number of micro-frames per sub-frame is 10 in the operation of the second mode period MD_2 described above, and thus the maximum value of the vertical axis is 10. In the example illustrated in FIG. 21, since the light reception count value in the exposure period in which the flight time is “6” is the maximum, the distance from the ranging device 1 to the object X is a distance corresponding to the flight time “6”.

As described above, in the ranging device 1 of the present embodiment, a plurality of exposure periods are arranged in one micro-frame period in the first mode period MD_1. Accordingly, as compared with the example of the first embodiment, the number of sub-frames in the first mode period MD_1 can be reduced without changing the cycle of the first timing. Although the number of sub-frames increases in the second mode period MD_2 as compared with the example of the first embodiment, the total measurement time of the first mode period MD_1 and the second mode period MD_2 may be reduced depending on the setting. In addition, the method of the present embodiment may be used in combination with a method of reducing the number of micro-frames per sub-frame in the second mode period MD_2 to be less than that in the first mode period MD_1. This further reduces the total measurement time.

### Fifth Embodiment

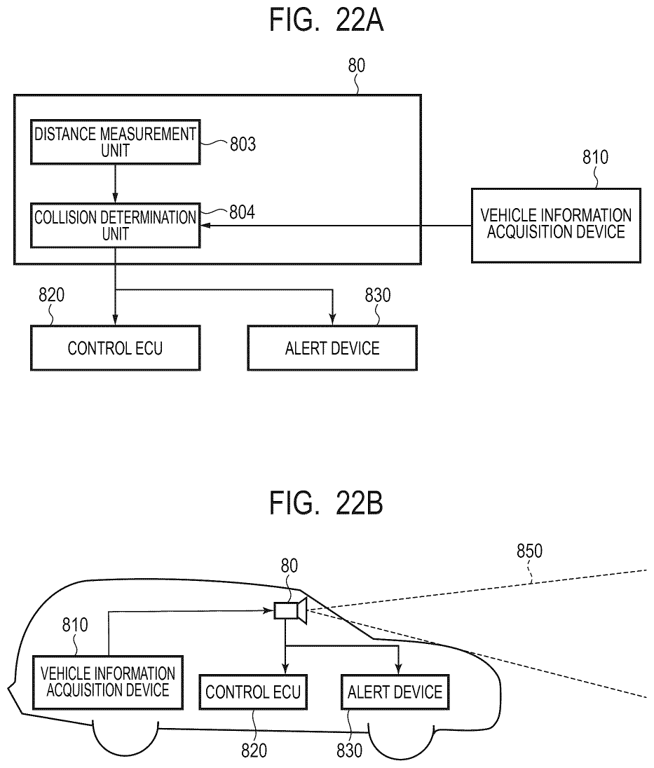

FIGS. 22A and 22B are block diagrams of equipment relating to an in-vehicle ranging device according to the present embodiment. Equipment 80 includes a distance measurement unit 803, which is an example of the ranging device 1 of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 22B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present disclosure is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present disclosure.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A+B) is omitted. This is because it is assumed that “A is not B” is considered when “A is B” is described.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present disclosure, and the technical scope of the present disclosure should not be construed as being limited by the embodiments. That is, the present disclosure can be implemented in various forms without departing from the technical idea or the main features thereof.

According to the present disclosure, a photoelectric conversion device capable of reducing a measurement time is provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-180216, filed Oct. 19, 2023, which is hereby incorporated by reference herein in its entirety.

What is claimed is:

1. A photoelectric conversion device comprising:
a timing generation unit configured to periodically generate a first timing indicating a light emission timing of a light emitting device in a first mode and periodically generate a second timing indicating a light emission timing of the light emitting device in a second mode;
a light receiving unit configured to generate a light reception signal based on incident light incident in an exposure period; and
an exposure period control unit configured to generate a control signal that controls a timing of the exposure period,
wherein a length of a cycle of the second timing is longer than a length of a cycle of the first timing,
wherein, in the first mode, the exposure period control unit generates the control signal indicating a timing of the exposure period having a time width corresponding to one of a plurality of periods into which one cycle of the first timing is divided, and
wherein the exposure period control unit determines the timing of the exposure period in the second mode based on a frequency distribution in which a count value of the light reception signal is associated with each of a plurality of the exposure periods in the first mode.

2. The photoelectric conversion device according to claim 1, wherein a time width of the exposure period in the second mode is equal to a time width of the exposure period in the first mode.

3. The photoelectric conversion device according to claim 1, wherein a time width of the exposure period in the second mode is shorter than a time width of the exposure period in the first mode.

4. The photoelectric conversion device according to claim 3, wherein one exposure period in the first mode corresponds to a plurality of exposure periods in the second mode.

5. The photoelectric conversion device according to claim 1, wherein the number of times of generation of the second timing in the exposure period corresponding to one flight time of light emitted from the light emitting device is less than the number of times of generation of the first timing in the exposure period corresponding to the one flight time.

6. The photoelectric conversion device according to claim 1, wherein the length of the cycle of the second timing is an integer multiple of the length of the cycle of the first timing.

7. The photoelectric conversion device according to claim 1, wherein one cycle of the second timing includes a ranging period in which the exposure period is set and a non-ranging period in which the exposure period is not set.

8. The photoelectric conversion device according to claim 1, wherein a plurality of the exposure periods are set corresponding to one cycle of the first timing.

9. The photoelectric conversion device according to claim 8, wherein one exposure period is set corresponding to one cycle of the second timing.

10. The photoelectric conversion device according to claim 1 further comprising a frequency distribution holding unit configured to hold the exposure period and the count value of the light reception signal in association with each other as the frequency distribution.

11. The photoelectric conversion device according to claim 10 further comprising a peak detection unit configured to perform peak detection processing of detecting an exposure period corresponding to a peak of the count values of the light reception signals based on the frequency distribution.

12. The photoelectric conversion device according to claim 11, wherein the peak detection unit performs the peak detection processing by detecting an exposure period corresponding to a maximum value of the count values of the light reception signals included in the frequency distribution.

13. The photoelectric conversion device according to claim 11, wherein the peak detection unit performs the peak detection processing by detecting an exposure period corresponding to a count value greater than a predetermined threshold value among the count values of the light reception signals included in the frequency distribution.

14. The photoelectric conversion device according to claim 11, wherein the peak detection unit performs the peak detection processing after the generation of the frequency distribution in the first mode is completed and before the generation of the frequency distribution in the second mode is started.

15. The photoelectric conversion device according to claim 11, wherein the peak detection unit performs the peak detection processing after the generation of the frequency distribution in the second mode is completed.

16. The photoelectric conversion device according to claim 11, wherein the exposure period control unit determines the timing of the exposure period in the second mode based on the timing of the exposure period corresponding to the peak in the first mode.

17. The photoelectric conversion device according to claim 1 further comprising:
a count value holding unit configured to hold a count value of the light reception signal; and
an output unit configured to output the count value to an outside.

18. The photoelectric conversion device according to claim 17, wherein the exposure period control unit determines the timing of the exposure period in the second mode by acquiring information based on the frequency distribution from an outside.

19. Equipment comprising:
the photoelectric conversion device according to claim 1; and
a processing device configured to process distance information acquired by the photoelectric conversion device.

20. A movable body comprising:
the photoelectric conversion device according to claim 1; and
a movable body control unit configured to control the movable body based on distance information acquired by the photoelectric conversion device.
